(19) United States
(12) Patent Application Publication
(10) Pub. No.: US 2015/0219458 A1
(43) Pub. Date: Aug. 6, 2015

(54) NAVIGATING TO A MOVING TARGET

(71) Applicant: ARUBA NETWORKS INC., Sunnyvale, CA (US)

(72) Inventors: Varun Shah, Sunnyvale, CA (US); Kiyo Kubo, Sunnyvale, CA (US); Nicholas Farina, Sunnyvale, CA (US)

(73) Assignee: ARUBA NETWORKS INC., Sunnyvale, CA (US)

(21) Appl. No.: 14/170,532

(22) Filed: Jan. 31, 2014

(51) Int. Cl. G01C 21/00; H04W 4/02

(52) U.S. Cl. CPC G01C 21/00; H04W 4/023

(57) ABSTRACT

A non-transitory computer readable medium with instructions which cause performance of: determining a location of a first client device corresponding to a first user and a location of a second client device corresponding to a second user, displaying directions to the second location, determining that the second client device has moved to a third location, and displaying updated directions to the third location.

### BACKGROUND

The use of the Internet, and other networks, has been rapidly increasing for years. Recently, WiFi has become common place in not only private locations, but also public areas. WiFi may be used for many things beyond simply accessing the Internet and e-mails.

### OVERVIEW

In general, in one aspect, embodiments relate to a non-transitory computer readable medium comprising instructions. The instructions, when executed on one or more processors, cause performance of operations comprising: determining a first location of a first client device corresponding to a first user and a second location of a second client device corresponding to a second user; displaying, on the first client device, a plurality of directions to the second location; determining that the second client device has moved to a third location; and displaying, on the first client device, a plurality of updated directions to the third location.

In general, in one aspect, embodiments relate to a system. The system comprises at least one processor; the system being configured to perform operations comprising: determining a first location of a first client device corresponding to a first user and a second location of a second client device corresponding to a second user; displaying, on the first client device, a plurality of directions to the second location; determining that the second client device has moved to a third location; and displaying, on the first client device, a plurality of updated directions to the third location.

In general, in one aspect, embodiments relate to a non-transitory computer readable medium comprising instructions. The instructions, when executed on one or more processors, cause performance of operations comprising: determining a first location of a first client device corresponding to a first user and a second location of a second client device corresponding to a second user; transmitting, to the first client device, a plurality of directions to the second location; determining that the second client device has moved to a third location; and transmitting, to the first client device, a plurality of updated directions to the third location.

In general, in one aspect, embodiments relate to a system. The system comprises at least one processor; the system being configured to perform operations comprising: determining a first location of a first client device corresponding to a first user and a second location of a second client device corresponding to a second user; transmitting, to the first client device, a plurality of directions to the second location; determining that the second client device has moved to a third location; and transmitting, to the first client device, a plurality of updated directions to the third location.

Other aspects and advantages will be apparent from the following description and the appended claims.

### BRIEF DESCRIPTION OF DRAWINGS

FIG. 1 shows a schematic diagram in accordance with one or more embodiments.

FIG. 2 shows a flowchart of a method in accordance with one or more embodiments.

FIG. 3 shows a computer system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that embodiments may be practiced without these specific details. In other instances, well-known features have not been described in detail to avoid unnecessarily complicating the description.

In general, embodiments provide a computer readable medium, a method, and a system for navigating to a moving target. In general, a network device receives a request from a first user to locate a second user. After the location of the second user is determined, the first user is navigated to the location of the second user. If the location of the second user changes, the navigation is updated so that the first user is directed to a current location of the second user. In one or more embodiments, the location of the users may be tracked based on Bluetooth signals, Global Positioning System (GPS) signals, Wi-Fi signals, and/or any other wireless signals.

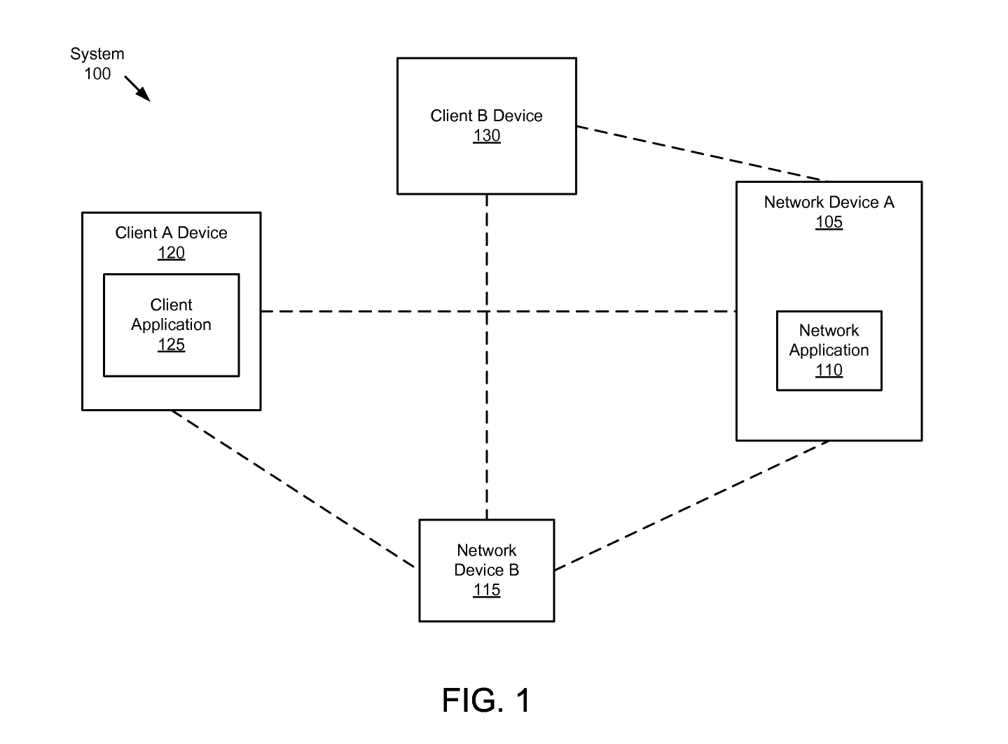

FIG. 1 shows a system (100) in accordance with one or more embodiments. As shown in FIG. 1, the system (100) has multiple components, including one or more network devices (e.g. network device A (105) and network device B (115)), client A device (120), and client B device (130). A network application (110) is executing on network device A (105) and a client application (125) is executing on the client A device (120). In one or more embodiments, network device A (105) and network device B (115) are located in the same IP subnet. In one or more embodiments, network device A (105) and network device B (115) are located in different IP subnets.

In one or more embodiments, each network device (105, 115) is a hardware device that is configured to receive packets (e.g., unicast packets, multicast packets) and transmit the packets to the client device(s) connected to the network device. A network device might also be configured to receive packets from a client device and transmit the packet to other network devices. The network device may include one or more hardware processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The hardware processor(s) may be an integrated circuit for processing instructions. For example, the hardware processor(s) may be one or more cores, or micro-cores of a processor.

By way of an example, a client device may be directly wired or wirelessly communicatively connected to a single access point, which is directly communicatively connected to a single controller, which is connected to a network (not shown). In the example, the network device may be the access point, the controller, an access point that includes the functionality of a controller, a switch (e.g., mobility access switch), or other such device. Additionally, by way of an example, one network device may be a controller while another network device may be an access point. The network device that is the access point in the example may or may not be connected to the network via the network device that is a controller.

Access points are digital devices that may be communicatively coupled to one or more networks (e.g., Internet, an intranet, etc.). In one or more embodiments, the network(s) may be password protected, or secured in any other suitable manner. Access points may be directly connected to the one or more networks or connected via a controller. In other words, an access point may be directly connected to a particular controller. An access point may include a wireless access point (WAP) that communicates wirelessly with devices using Wi-Fi, Bluetooth or related standards and that communicates with a wired network.

The network application (110) includes functionality for identifying the physical location of client devices (e.g., client A device (120), client B device (130)), determining instructions for navigating a user to a location, sending a user navigation instructions and other functionalities as needed for implementing the embodiments. In one or more embodiments, network application (110) may work in conjunction with the various network devices (e.g., network device A (105) and network device B (115)) to identify the physical location of client devices. Alternatively or additionally, a single network device may identify the location of client devices. Specifically, Wi-Fi may be used to identify the physical location of client devices using any suitable method, such as Wi-Fi triangulation, or other technology. In Wi-Fi triangulation, the strength of the signal(s) received by various network devices is measured. Through the relative strengths of the signals, and the known locations of the network devices, the location of client device can be determined with very high accuracy. It will be apparent to one of ordinary skill in the art that there are many ways to identify location using Wi-Fi and, as such, the embodiments should not be limited to the above examples. Further, other standards and signals may be used to track locations, such as Bluetooth, GPS, or other wireless signals.

The use of Wi-Fi for identifying the locations of client devices has many advantages. First, no additional software is needed for the vast majority of client devices—whether the client device is a mobile phone, laptop, netbook, smartwatch, smartglasses, or other device, most modern devices include functionality to send and receive Wi-Fi signals. This base functionality is sufficient to identify the location of the associated device using Wi-Fi based methods. Further, Wi-Fi based location identification is able to track many different client devices simultaneously.

In one or more embodiments, network application (110) includes functionality for navigating a user to a location, such as to the location of a second user/client device. Network application (110) may know the layout of the public area, building, or other area in which a user may be located. The layout may be preloaded or stored in a local database, or may be accessed from an online website, the cloud, or any other suitable source. The layout may identify the available paths (e.g., roads, hallways, rooms, tunnels, stairs, elevators, etc.) which a user may take to arrive at a specified location. Network application (110) may use the layout to determine the shortest route, fastest route, easiest route, least congested/populated route, or any other route by which to guide a user to their desired location. Once network application (110) has generated the steps to guide a user to their desired location, the steps may be sent to the user's client device for display or audio readout in any manner now known or later developed.

In one or more embodiments, network application (110) includes functionality to update the navigation steps/directions based on a second user having a new location (i.e., the second user moved to a different room, is walking around the office, etc). Network application (110) may check if a user has an updated (new) location on a periodic basis (e.g., every 10 seconds, 30 seconds, minute, etc.), on a random basis, on an event (e.g., roaming), or on any other basis. When a new location is found for a user which is the target of a navigation attempt, the steps for the navigation will be updated. In one or more embodiments, the update may be performed in a manner similar to the initial determining of navigation steps (e.g., based on shortest route, least busy/populated route, etc.). When a user has his or her navigation steps updated, the user may be notified. Alternatively, the user may not be notified. In one or more embodiments, the updating of navigation steps is automatic.

In one or more embodiments, client A device (120) and client B device (130) may be a computing system capable of wirelessly sending and/or receiving information. For example, client A device (120) and/or client B device (130) may be a laptop computer, smartphone, cell phone, personal digital assistant, tablet computer, handheld video game system, or other mobile device.

In one or more embodiments, client application (125) is a software application executing on client A device (120) that includes the functionality needed for interaction with the network devices. Client application (125) may be installed by the user of client A device (120) or may come pre-installed by the manufacturer. In one or more embodiments, client application (125) is part of the operating system, or other standard pre-installed software, of client A device (120), as the embodiments may be practiced without the installation of specialized software on client devices. In one or more embodiments, client A device (120) and/or client B device (130) do not have client application (125) installed.

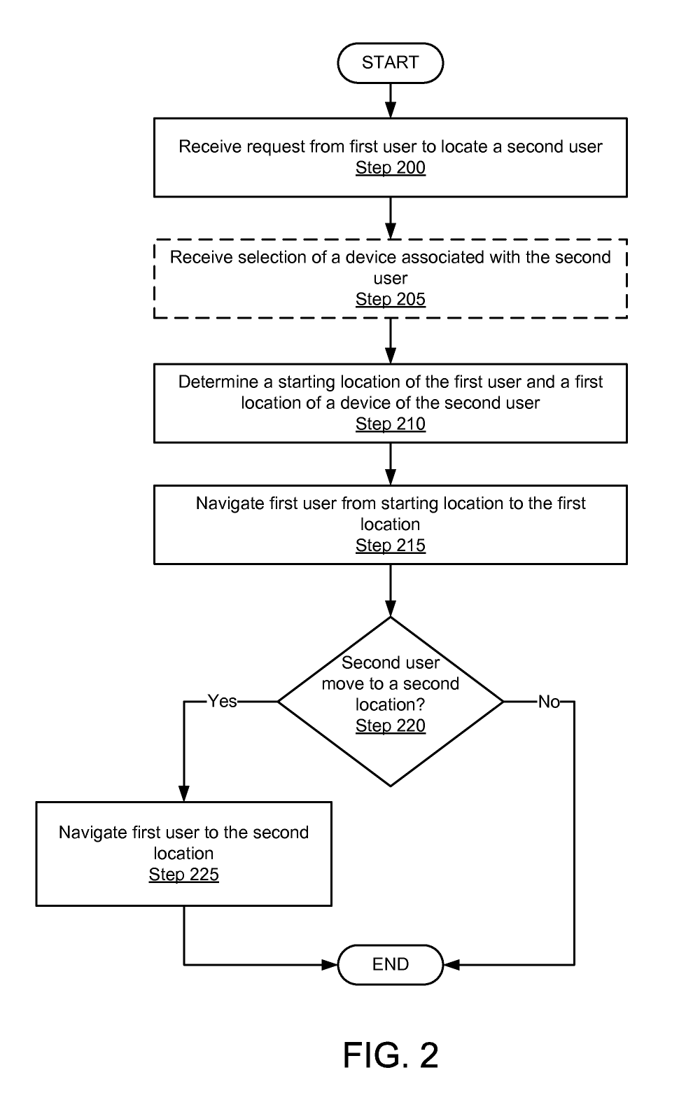

FIG. 2 shows a flowchart depicting a process/method for navigating to a moving target. While the various steps in this flowchart are presented and described sequentially, one of ordinary skill in the art will appreciate that some or all of the steps may be executed in different orders and some or all of the steps may be executed in parallel. Further, in one or more embodiments, one or more of the steps described below may be omitted, repeated, and/or performed in a different order. Accordingly, the specific arrangement of steps shown in FIG. 2 should not be construed as limiting the scope of the embodiments.

In Step 200, a request is received from a first user to locate a second user, in accordance with one or more embodiments. The request may be received in any manner now known or later developed. The second user may be identified by any suitable manner including, but not limited to, device name, phone number, Internet Protocol (IP) Address, first name, last name, type of device, screen name, other contact information, any other suitable manner and/or various combinations of the above examples.

In Step 205, a selection of a device associated with the second user is received, in accordance with one or more embodiments. Step 205 is optional, as shown by the dotted lines. The selection of a device associated with the second user may involve, for example, selecting whether to be navigated to the location of a laptop or a cell phone controlled and/or owned by the second user. In an office environment, the laptop may direct the first user to the desk where the second user works, but the second user may or may not be there. In one or more embodiments, a cell phone, smartphone, or other similar device is the default client device to which a user will be navigated.

In Step 210, a starting location of the first user and a first location of a client device of the second user are identified, in accordance with one or more embodiments. The location of client devices may be identified using Wi-Fi triangulation, Bluetooth, GPS, or otherwise wireless technologies. The accuracy of the location may be within any suitable amount, such as 5 feet, 50 feet, 100 feet, etc. In one or more embodiments, the locations of users may be continuously tracked by the network device(s), or may be determined on an as-needed basis.

In Step 215, the first user is navigated from the starting location to the first location, in accordance with one or more embodiments. The first user may be navigated by following step by step instructions. The instructions may be generated by a network device, a client device, or any other suitable device. The instructions may take into consideration hallways, roads, walkways, or other suitable paths where the user may travel, and may plot a variety of different routes for the user to select. For example, one route may be the fastest, while a second route may be less busy or avoid zones where the user is prohibited from entering. One or more routes may avoid stairs. One or more routes may avoid individuals or offices specified by the user. Once generated, the steps may be sent to the client device of the first user in any manner now known or later developed. The navigation may be displayed on a map, picture, or other suitable background, and may or may not include a listing of the steps. The client device may execute an audio readout of the navigation.

In Step 220, a determination is made whether the second user has moved to a second location, in accordance with one or more embodiments. Step 220 may be performed as many times as necessary while a user is navigating toward the second user. The determination may be made in any manner now known or later developed, and may be made at any time. In one or more embodiments, the location(s) of users are updated on a periodic basis, such as every 10 seconds, 30 seconds, minute, etc. In one or more embodiments, a user will not be determined to have moved from a location unless the new location is at least a threshold distance away from the old location—such as 10 feet, 50 feet, 100 feet, etc. If the second user has not moved to a new location, the method ends. If the second user has moved to a new location, the method proceeds to Step 225.

In Step 225, the first user is navigated to the second location, in accordance with one or more embodiments. The first user may be navigated to the second location in much the same manner as he or she was being navigated to the first location. Step by step instructions will be generated to guide the user from their current location to the second location, and the steps will be sent to the user. After Step 225, the method ends.

The following section describes various examples. The examples are included to aid in the understanding of the embodiments and are not intended to limit scope.

As a first example, a large Las Vegas casino has free WiFi available throughout the structure. All guests & visitors may connect to the WiFi. Bob is trying to meet up with his friend, Gary, who arrived at the casino before Bob, Gary is already gambling the night away at the poker tables. Bob calls Gary on his cell phone, but Gary is too busy going all-in to answer the phone and tell Bob where he is. Luckily for Bob, the casino has navigation available to users who connect to the free WiFi. Bob searches for, and finds, Gary's cell phone via the free WiFi. Bob then requests to be navigated to Gary's current location. Step by step instructions for how to get to the poker tables where Gary is playing appear on Bob's phone. Bob begins walking to Gary. While Bob is on his way, Gary loses everything on one of his many all-ins. Gary gets up and leaves the poker table in disgust, and moves to a bank of slot machines to try his luck. If the casino did not support navigation to a moving target. Bob would arrive at the poker table where Gary was gambling before he moved on to the slot machine. However, the casino does support navigation to a moving target, and Bob's step by step instructions are automatically updated to direct Bob to the slot machine where Gary is continuing to lose more money. By following the instructions. Bob arrives at Gary's location, and the two proceed to gamble the night away.

As a second example, John and Tim are employees at a Large Corporation working on a project together. The Large Corporation has a corporate campus spanning multiple buildings, and people are frequently assigned new offices and desks. Private, secure WiFi is available throughout the corporate campus to all employees. One afternoon, John receives an urgent e-mail from management which he must discuss with Tim, John tries calling Tim's desk and cell phone, but is unable to get an answer. John then tries to locate Tim on the employee WiFi network by searching for Tim by name. Two devices associated with Tim are found to be presently connected to the network—a laptop and a cell phone. John selects Tim's cell phone as the device lie would like to be navigated to, as John believes that Tim should have his cell phone in his pocket. The navigation instructions quickly appear on John's phone leading him to the location of Tim's cell phone. As John is following the navigation instructions, he notices that the instructions are being automatically updated as Tim's cell phone moves around. When John catches up to the moving cell phone, Tim is no where to be found—only a security guard is there. Tim misplaced his phone. Not a problem—John takes the phone from the security guard so that he may return it to Tim, and changes his navigation target to Tim's laptop which is also connected to the employee WiFi network. Seconds later navigation instructions appear on John's phone leading him to the location of Tim's laptop. When John arrives at the location, Tim is busy working away, oblivious to the urgent e-mail from management. John returns Tim's cell phone and the two are able to fix the issue identified by management.

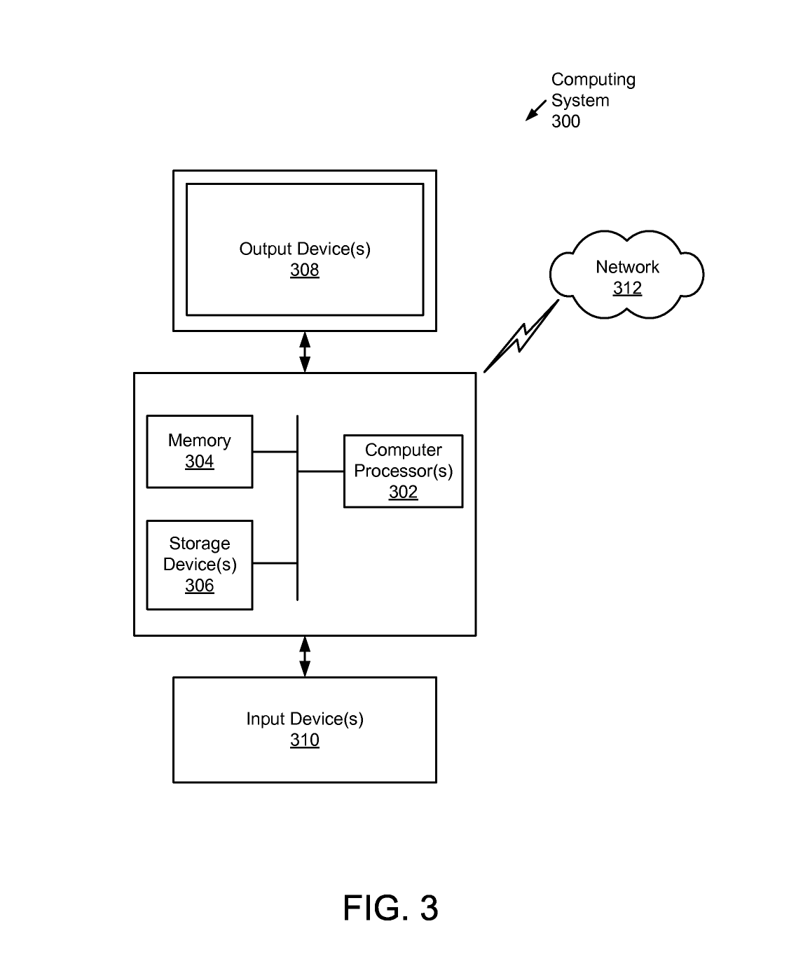

Embodiments may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 3, the computing system (300) may include one or more computer processor(s) (302), associated memory (304) (e.g., random access memory (RAM), cache memory, flash memory, etc.), one or more storage device(s) (306) (e.g., a hard disk, an optical drive such as a compact disk (CD) drive or digital versatile disk (DVD) drive, a flash memory stick, etc.), and numerous other elements and functionalities. The computer processor(s) (302) may be an integrated circuit for processing instructions. For example, the computer processor(s) may be one or more cores, or micro-cores of a processor. The computing system (300) may also include one or more input device(s) (310), such as a touchscreen, keyboard, mouse, microphone, touchpad, electronic pen, or any other type of input device. Further, the computing system (300) may include one or more output device(s) (308), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (300) may be connected to a network (312) (e.g., a local area network (LAN), a wide area network (WAN) such as the Internet, mobile network, or any other type of network) via a network interface connection (not shown). The input and output device(s) may be locally or remotely (e.g., via the network (312)) connected to the computer processor(s) (302), memory (304), and storage device(s) (306). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (300) may be located at a remote location and connected to the other elements over a network (312). Further, embodiments may be implemented on a distributed system having a plurality of nodes, where each portion of an embodiment may be located on a different node within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A non-transitory computer readable medium comprising instructions which, when executed on one or more processors, cause performance of operations comprising:
determining a first location of a first client device corresponding to a first user and a second location of a second client device corresponding to a second user;
displaying, on the first client device, a plurality of directions to the second location;
determining that the second client device has moved to a third location; and
displaying, on the first client device, a plurality of updated directions to the third location.

2. The medium of claim 1, wherein determining that the second client device has moved to the third location comprises periodically checking a current location of the second client device.

3. The medium of claim 1, wherein displaying the plurality of updated directions is responsive to determining that the second location is at least a threshold distance from the third location.

4. The medium of claim 1, wherein the second user is associated with a plurality of client devices, and wherein the first user identifies the second client device as a target device for the plurality of directions.

5. The medium of claim 1, wherein the plurality of updated directions to the third location is displayed as the first client device is moving toward the second location from the first location.

6. A system comprising:
at least one processor;
the system being configured to perform operations comprising:
determining a first location of a first client device corresponding to a first user and a second location of a second client device corresponding to a second user;
displaying, on the first client device, a plurality of directions to the second location;
determining that the second client device has moved to a third location; and
displaying, on the first client device, a plurality of updated directions to the third location.

7. The system of claim 6, wherein determining that the second client device has moved to the third location comprises periodically checking a current location of the second client device.

8. The system of claim 6, wherein displaying the plurality of updated directions is responsive to determining that the second location is at least a threshold distance from the third location.

9. The system of claim 6, wherein the second user is associated with a plurality of client devices, and wherein the first user identifies the second client device as a target device for the plurality of directions.

10. The system of claim 6, wherein the plurality of updated directions to the third location is displayed as the first client device is moving toward the second location from the first location.

11. A non-transitory computer readable medium comprising instructions which, when executed on one or more processors, cause performance of operations comprising:
determining a first location of a first client device corresponding to a first user and a second location of a second client device corresponding to a second user;
transmitting, to the first client device, a plurality of directions to the second location;
determining that the second client device has moved to a third location; and
transmitting, to the first client device, a plurality of updated directions to the third location.

12. The medium of claim 11, wherein determining that the second client device has moved to the third location comprises periodically checking a current location of the second client device.

13. The medium of claim 11, wherein transmitting the plurality of updated directions is responsive to determining that the second location is at least a threshold distance from the third location.

14. The medium of claim 11, wherein the second user is associated with a plurality of client devices, and wherein the first client device identifies the second client device as a target device for the plurality of directions.

15. The medium of claim 11, wherein the plurality of updated directions to the third location is transmitted as the first client device is moving toward the second location from the first location.

16. A system comprising:
at least one processor;
the system being configured to perform operations comprising:
determining a first location of a first client device corresponding to a first user and a second location of a second client device corresponding to a second user;
transmitting, to the first client device, a plurality of directions to the second location;
determining that the second client device has moved to a third location; and
transmitting, to the first client device, a plurality of updated directions to the third location.

17. The system of claim 16, wherein determining that the second client device has moved to the third location comprises periodically checking a current location of the second client device.

18. The system of claim 16, wherein transmitting the plurality of updated directions is responsive to determining that the second location is at least a threshold distance from the third location.

19. The system of claim 16, wherein the second user is associated with a plurality of client devices, and wherein the first client device identifies the second client device as a target device for the plurality of directions.

20. The system of claim 16, wherein the plurality of updated directions to the third location is transmitted as the first client device is moving toward the second location from the first location.
